(19) United States
(12) Patent Application Publication
(10) Pub. No.: US 2011/0188499 A1
(43) Pub. Date: Aug. 4, 2011

(54) POINT-TO-MULTIPOINT PATH IMPLEMENTATION IN A MULTICAST VIRTUAL PRIVATE NETWORK

(75) Inventors: Jacob Ijsbrand Wijnands, Leuven (BE); Rajesh Sharma, Cupertino, CA (US)

(73) Assignee: Cisco Technology, Inc., San Jose, CA (US)

(21) Appl. No.: 12/700,606

(22) Filed: Feb. 4, 2010

(51) Int. Cl. H04L 12/56

(52) U.S. Cl. 370/390

(57) ABSTRACT

In an example embodiment, a method at a first routing device is provided. In this method, the first routing device receives an interest for multicast traffic that is transmitted downstream along a point-to-multipoint path in a multicast virtual private network. This interest identifies a source address and/or a multicast group address. Upon receipt of the interest, the first routing device identifies a second routing device, which is upstream to the first routing device, based on the source address and/or the multicast group address. On condition of receipt of the interest, the first routing device creates a bidirectional path between itself and the second routing device.

### FIELD

The present disclosure relates generally to computer networks.

### BACKGROUND

In a virtual private network with hub and spoke deployment, data is typically transmitted from a single hub to multiple spoke sites. In a multicast virtual private network, sources are mostly co-located in a data center and accordingly, data is also transmitted from a single site (e.g., data center) to multiple sites. In current hub and spoke deployment, a full mesh of paths or tunnels is constructed between all sites to allow communication between the sites. However, the construction and maintenance of a full mesh may, for example, consume a large amount of bandwidth.

### BRIEF DESCRIPTION OF DRAWINGS

The present disclosure is illustrated by way of example and not limitation in the figures of the accompanying drawings, in which like references indicate similar elements and in which:

FIG. 1 depicts a diagram of an example of a computer network, consistent with an example embodiment;

FIG. 2 depicts a block diagram of a multicast module, in accordance with an embodiment, included in an apparatus;

FIG. 3 depicts a flow diagram of a general overview of a method, in accordance with an example embodiment, for implementing point-to-multipoint paths in multicast virtual private networks;

FIGS. 4A and 4B depict diagrams illustrating the implementation of a point-to-multipoint path in a multicast virtual private network based on protocol independent multicast (PIM), in accordance with an example embodiment;

FIG. 5 depicts a flow diagram of a general overview of a method, in accordance with an example embodiment, for implementing a point-to-multipoint path in a multicast virtual private network from the viewpoint of an upstream routing device;

FIG. 6 depicts a diagram illustrating the relaying of an interest for multicast traffic, in accordance with an example embodiment;

FIG. 7 depicts a timing diagram illustrating the creation of a bidirectional path between two routing devices based on PIM source specific multicast protocol, according to an example embodiment; and

FIG. 8 depicts a block diagram of a machine in the example form of an apparatus within which may be executed a set of instructions for causing the machine to perform any one or more of the methodologies discussed herein.

### DESCRIPTION OF EXAMPLE EMBODIMENTS

In the following description, for purposes of explanation, numerous specific details are set forth in order to provide a thorough understanding of an example embodiment of the present disclosure. It will be evident, however, to one skilled in the art that the present disclosure may be practiced without these specific details.

Overview

A method at a first routing device is provided. In this method, the first routing device receives an interest for multicast traffic that is transmitted downstream along a point-to-multipoint path in a multicast virtual private network. This interest identifies a source address and/or a multicast group address. Upon receipt of the interest, the first routing device identifies a second routing device, which is upstream to the first routing device, based on the source address and/or the multicast group address. On condition of receipt of the interest, the first routing device creates a bidirectional path between itself and the second routing device. As referred herein, it should be noted that the terms “first,” “second,” or the like do not necessarily imply an order or sequence.

Another method at a first routing device is provided. In this method, the first routing device receives an interest for multicast traffic from a second routing device, which is downstream from the first routing device. This multicast traffic is transmitted downstream along a point-to-multipoint path is a multicast virtual private network. On condition of receipt of the interest, the first routing device creates a bidirectional path between itself device third routing device that is downstream from the first routing device, where this third routing device is in the point-to-multipoint path. The first routing device then relays the interest to this third routing device, thereby triggering join suppression or prune override at the third routing device.

### Example Embodiments

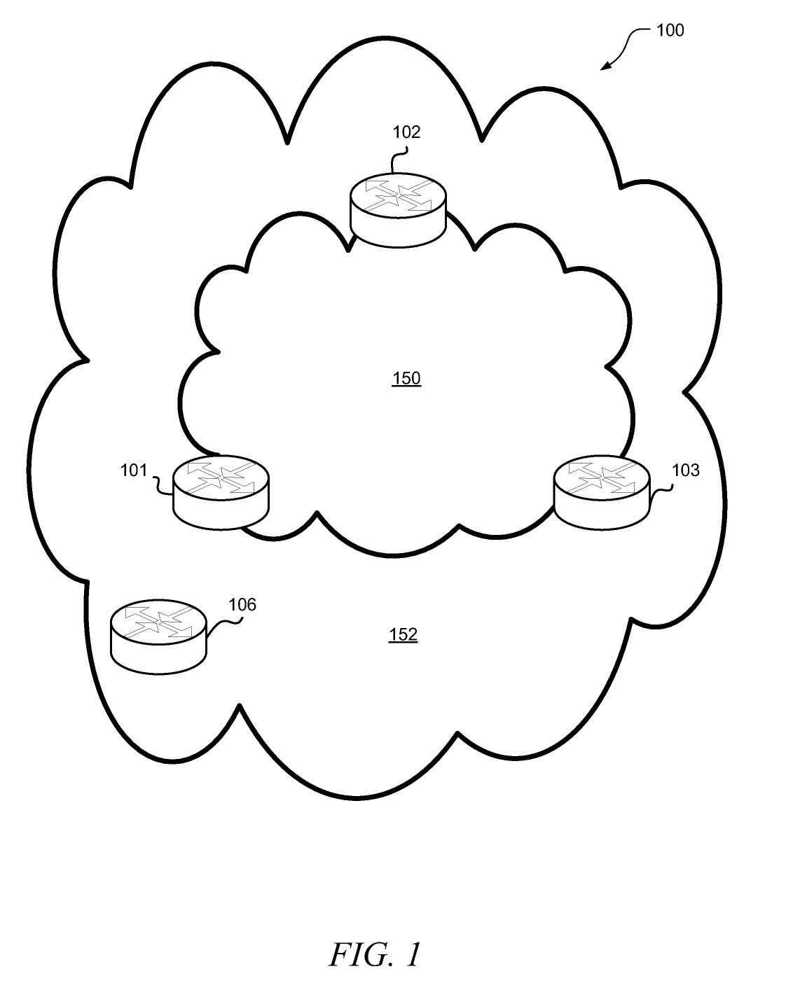

FIG. 1 depicts a diagram of an example of a computer network 100, consistent with an example embodiment. This computer network 400 includes a provider domain 150 (or core network) and a customer domain 152 that are interconnected by routing devices 101-103 and 106. A domain (e.g., the provider domain 150 or the customer domain 152) is a collection of network nodes under the control of one or more entities that present a common routing policy. The domain may also be referred to as an autonomous system or community. In one embodiment, the provider domain 150 is a multicast virtual private network (MVPN). In general, a multicast virtual private network is used for distributing data or traffic to multiple receivers within the customer domain 152 at approximately the same time. For example, a multicast packet has a single source Internet Protocol (IP), but it has a multicast destination IP address that is delivered to a group of receivers. In a multicast virtual private network, multicast packets from the customer domain 152 are encapsulated and routed within the provider domain 150.

The distinct networks within domains 150 and 152 can be coupled together by the routing devices 101-103 and 106. For Layer-3 services, the routing devices 101-103 and 106 are configured to communicate by way of, for example, Border Gateway Protocol (BGP). A provider edge (PE) routing device (e.g., PE routing devices 101-103) is an example of an inter-domain routing device. APE routing device 101, 102, or 103 can be placed at the edge of a Service Provider (SP) network, and may communicate by way of a routing protocol to another PE routing device or domain. A customer edge (CE) routing device (e.g., CE routing device 106), which may be a multi-homed device, can be located at the edge of a network associated with a customer or subscriber. It should be noted that a number of network nodes (e.g., routing devices 101-103 and 106) and communication links may be included in the computer network 100, and that the computer network 100 depicted in FIG. 1 shown herein is for simplicity.

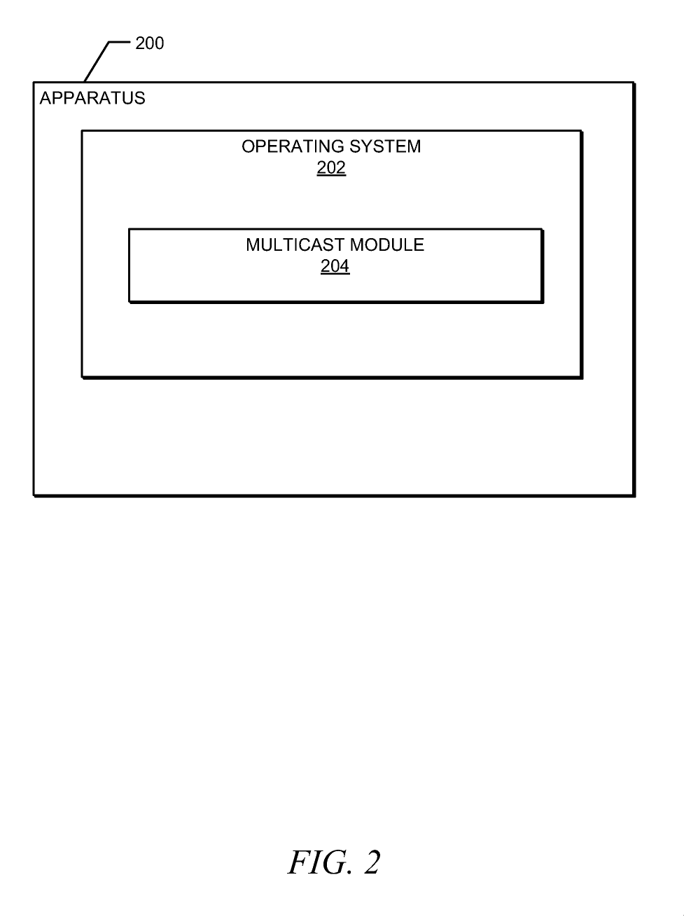

FIG. 2 depicts a block diagram of a multicast module 204, in accordance with an embodiment, included in an apparatus 200. It should be appreciated that the apparatus 200 may be deployed in the form of a variety of routing devices, such as the PE routing devices 101-103 depicted in FIG. 1. In various embodiments, the apparatus 200 may be used to implement computer programs, logic, applications, methods, processes, or other software to implement a point-to-multipoint path in a multicast virtual private network, as described in more detail below.

The apparatus 200 includes an operating system 202 (e.g., an Internetworking Operating System) that manages the software processes and/or services executing on the apparatus 200. As depicted in FIG. 2, these software processes and/or services may include a multicast module 204. In general, the multicast module 204 is adapted to transmit multicast data traffic (or “multicast traffic”) along one or more point-to-multipoint paths in a multicast virtual private network. However, as will be explained in more detail below, the multicast module 204 is adapted to transmit control traffic or control messages along one or more bidirectional paths, which are dynamically created based on demand. As used herein, a “point-to-multipoint path,” is a data communication path that has one ingress routing device and one or more egress routing devices. An ingress routing device functions as a sender of a path. An egress routing device functions as a receiver of a path. As such, the point-to-multipoint path is unidirectional, where data flows only downstream from one to many routing devices. The source of the multicast traffic is considered upstream while downstream is in the opposite direction. As an example, a point-to-multipoint path may be comprised of multiple traffic engineering links from one ingress label (or IP) switch routing device to multiple egress label (or IP) switch routing devices.

It should be appreciated that in other embodiments, the apparatus 200 may include fewer or more modules apart from those shown in FIG. 2. For example, the multicast module 204 may be separated into two modules where one module is adapted to create the bidirectional path on demand while another module, as explained in more detail below, is adapted to relay any suitable control messages to other routing devices connected to the point-to-multipoint path.

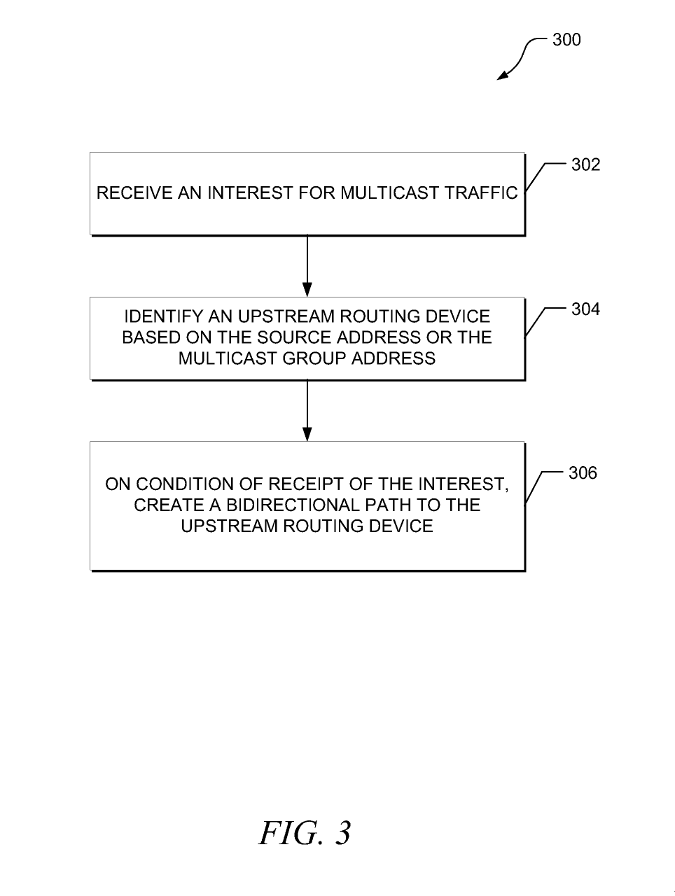

FIG. 3 depicts a flow diagram of a general overview of a method 300, in accordance with an example embodiment, for implementing a point-to-multipoint paths in multicast virtual private networks. In an example embodiment, the method 300 may be implemented by the multicast module 204 and employed in the apparatus 200 depicted in FIG. 2. As depicted in FIG. 3, a routing device receives an interest for multicast traffic at 302 from another routing device. This interest is a type of control message or control traffic. For example, this interest may be a protocol independent multicast (PIM) join message, which is a request to connect or join to a particular point-to-multipoint path that may, for example, be requested within a customer domain or a provider domain. It should be noted that a PIM message (e.g., PIM join message) transmitted within the customer domain may be referred to as the customer domain PIM message. A PIM message that is transmitted within the provider domain may also be referred to as a provider domain PIM message. In another example, this interest may be an Internet gateway to management protocol (IGMP) report message, which is also a request to connect or join to a point-to-multipoint path and this request may, for example, be transmitted within a customer domain. The interest (e.g., a PIM join message or an IGMP report message) includes a source address and/or a multicast group address. It should be appreciated that a source address is a unicast address that identifies a source and, for example, may be used to determine the data stream direction. Examples of source addresses include IPv4 and IPv6 addresses. As an example, a source address may be encoded as an Encoded-Source Address in a PIM join message. A multicast group address is an identifier for a group of, for example, hosts that have joined a multicast group. Examples of multicast group address include IPv4 and IPv6 multicast addresses. A particular point-to-multipoint path can be identified by the source address and/or multicast group address.

Still referring to FIG. 3, upon receipt of the interest, the routing device then identifies an upstream routing device at 304 based on the source address and/or the multicast group address. In one embodiment, the upstream routing device can be identified by conducting a reverse path lookup of an address of the upstream routing device based on the source address. For example, by locating the source address in a unicast table or a multicast table, a destination Internet protocol (IP) address of the upstream routing device can be located within the unicast table using a reverse path lookup. In another embodiment, the upstream routing device can be identified by conducting a reverse path lookup of an address of the upstream routing device based on a rendezvous point associated with the multicast group address. A rendezvous point refers to a routing device in a multicast virtual private network that acts as a shared root for the point-to-multipoint path.

Only on the condition of receipt of the interest, the routing device then creates a bidirectional path between itself and the upstream routing device at 306. That is, without receipt of the interest, the routing device is prohibited from creating the bidirectional path. In effect, the creation of a bidirectional path creates a bidirectional multicast distribution core tree between itself and the upstream routing device. A bidirectional multicast distribution core tree refers to a multipoint-to-multipoint path with bidirectional connectivity. A single bidirectional path can be created based on two unidirectional paths using protocol independent multicast (PIM), Resource Reservation Protocol-Traffic Engineering (RSVP-TE), multicast label distribution protocol (mLDP), or other core building protocols. For example, in one embodiment, a single bidirectional path can be based on two PIM source trees, which is explained in more detail below. In other embodiments, a single bidirectional path can be created with two point-to-multipoint paths built with RSVP-TE or mLDP. As a result of the creation of the bidirectional path, the routing devices can send and receive control and multicast data between each other.

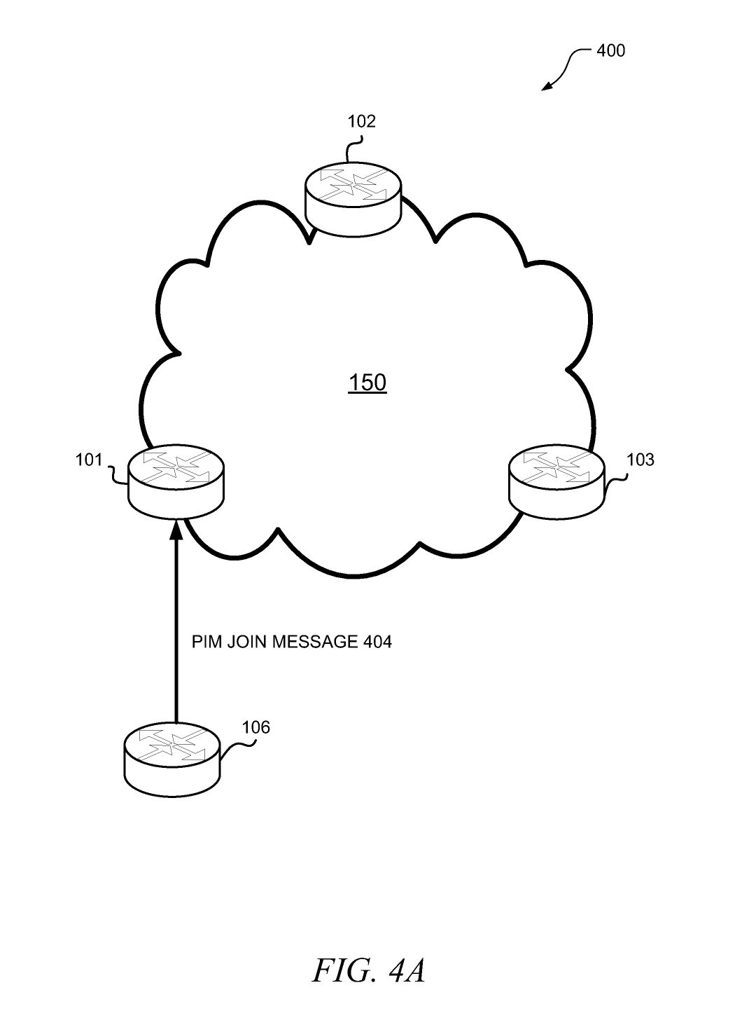

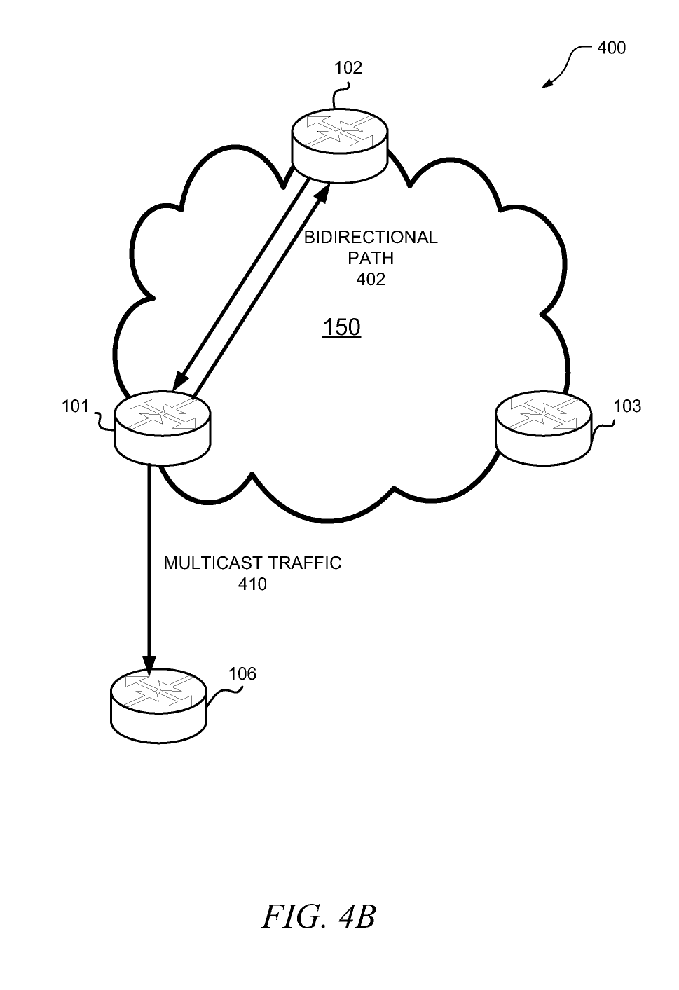

FIGS. 4A and 4B depict diagrams illustrating the implementation of a point-to-multipoint path in a multicast virtual private network based on PIM, in accordance with an example embodiment. The computer network 400, as depicted, includes a provider domain 150 that is interconnected by PE routing devices 101-103. Additionally included in the computer network 400 is a CE routing device 106 that is in communication with the PE routing device 101. Within the provider domain 150 is the multicast virtual private network.

As depicted in FIG. 4A, the CE routing device 106 transmits to the PE routing device 101 an interest for multicast traffic by transmitting a PIM join message 404. Here, the PIM join message 404 includes a source address and a multicast group address. Upon receipt of this PIM join message 404 at a multicast virtual private network port, the PE routing device 101 identifies an upstream routing device based on the source address and the multicast group address included in the PIM join message 404. In this example, the PE routing device 101 identifies that the PE routing device 102 is an upstream routing device by a reverse path lookup of the source address in a unicast table.

As depicted in FIG. 4B, only on condition of receipt of the PIM join message 404, the PE routing device 101 creates a bidirectional path 402 between itself and the PE routing device 102 using PIM. In one example, the PE routing device 101 can create this bidirectional path 402 by constructing a bidirectional multicast distribution core tree with bidirectional connectivity to the PE routing device 102. As also explained in more detail below, the bidirectional path 402 may, for example, be created by way of two unidirectional paths. As a result of the creation of the bidirectional path 402, the CE routing device 106 can then receive multicast traffic 410. It should also be noted that another bidirectional path (not shown) may be created between PE routing devices 102 and 103 based on the above-discussed techniques if PE routing device 103 receives an interest for multicast traffic.

Therefore, instead of a full mesh of bidirectional paths between all PE routing devices 101, 102, and 103, the PE routing device 101 creates a single bidirectional path 402 between itself and the PE routing device 102. As discussed above, this bidirectional path 402 is created on condition of receipt of, for example, the PIM join message 404 or other control messages. That is, the PE routing device 101 in this example creates this bidirectional path 402 only if it receives an interest from the CE routing device 106 for multicast traffic 410. Without receipt of the interest, the PE routing device 101 will not create the bidirectional path 402.

The PE routing device 101 basically creates the bidirectional path 402 when needed or requested, thereby emulating multipoint-to-multipoint connectivity when needed. The creation of the bidirectional path 402 is therefore based on demand. This selective creation of the bidirectional path 402 when needed may, for example, may reduce the amount of data traffic transmitted between the PE routing devices 101-103 because unlike control messages, data traffic is transmitted by way of one or more point-to-multipoint paths. In one embodiment, the bidirectional path 402 can be dynamically created as needed and removed when not needed. For example, the PE routing device 101 can identify a lapse of a period of time after withdrawal of interest for multicast traffic by the PE routing device 102. This period of time may be predefined. After this period of time has elapsed, the PE routing device 101 removes itself from the bidirectional multicast distribution core tree, thereby effectively removing the bidirectional path 402. In another example, either PE routing device 101 or 102 may also withdraw interest by transmitting a prune message, which is a request to remove itself from the bidirectional multicast distribution core tree and this request may, for example, be transmitted within a customer domain.

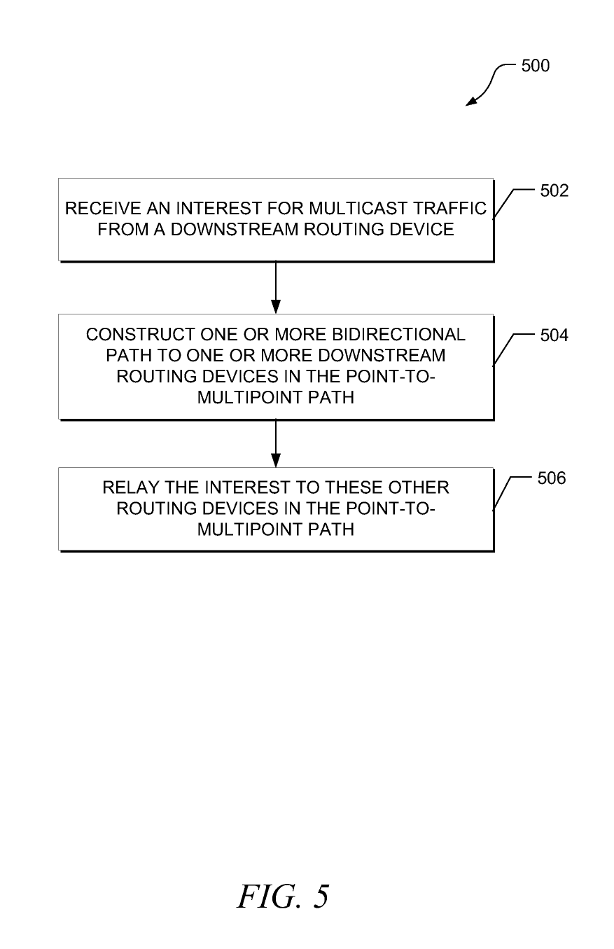

FIG. 5 depicts a flow diagram of a general overview of a method 500, in accordance with an example embodiment, for implementing a point-to-multipoint path in a multicast virtual private network from the viewpoint of an upstream routing device. In an example embodiment, the method 500 may be implemented by the multicast module 204 and employed in the apparatus 200 depicted in FIG. 2. As depicted in FIG. 5, an upstream routing device receives an interest for multicast traffic from a “first” downstream routing device at 502. Here, the interest for the multicast traffic may, for example, be received in the form of a PIM join request or an IGMP report message by way of a bidirectional path, as discussed above.

It should be appreciated that before the receipt of the interest, the upstream routing device may initially announce that it is connected to a multicast source or multicast rendezvous point and therefore, has multicast data available for broadcast. Such an announcement may be in the form of a path attribute advertisement, which may include BGP Multicast Distribution Tree (MDT) subaddress family identifier information (SAFI) or BGP Auto-Discovery (A-D), which are explained in more detail below. With receipt of such an advertisement, other routing devices can identify that the upstream routing device, which transmitted the advertisement, has multicast data for broadcast. Additionally, before receipt of the interest from the downstream routing device, the upstream routing device joins the downstream routing device such that the upstream routing device can receive the interest. The downstream routing device can initiate such a join by signaling the upstream routing device with, for example, a request to construct a bidirectional path.

On condition of receipt of this interest, the upstream routing device creates, at 504, one or more additional bidirectional paths between itself and one or more “other” downstream routing devices in the point-to-multipoint path. As explained in more detail below, the bidirectional paths can be created based on two unidirectional paths.

Additionally, the upstream routing device also relays the received interest to these other routing devices in the point-to-multipoint path at 506. That is, the upstream routing device loops back the interest it received to some or all the other routing devices connected to the point-to-multipoint path. The relaying of the interest may trigger join suppression at these other routing devices. In particular, the relaying of the interest notifies these other routing devices not included in the initially established bidirectional path that bidirectional connectivity to the “first” routing device has been established. As a result, these other routing devices may be automatically configured to suppress transmission of any interest for multicast traffic, but can further relay control traffic or can be signaled by downstream routing devices in path attributes.

It should be appreciated that the upstream routing device can also relay other control messages, such as prune messages. Upon receipt of a prune message (e.g., a PIM prune message), the upstream routing device relays this prune message to other routing devices in the point-to-multipoint path. The relaying of the prune message may trigger prune override at these other routing devices. As discussed above, routing devices in the point-to-multipoint path may be configured to automatically remove themselves from the bidirectional multicast distribution core tree (or remove the bidirectional path) after, for example, a certain period of inactivity. Such routing devices may remove themselves by transmitting PIM prune messages. In prune override, these routing devices are configured to automatically suppress transmission of any prune messages.

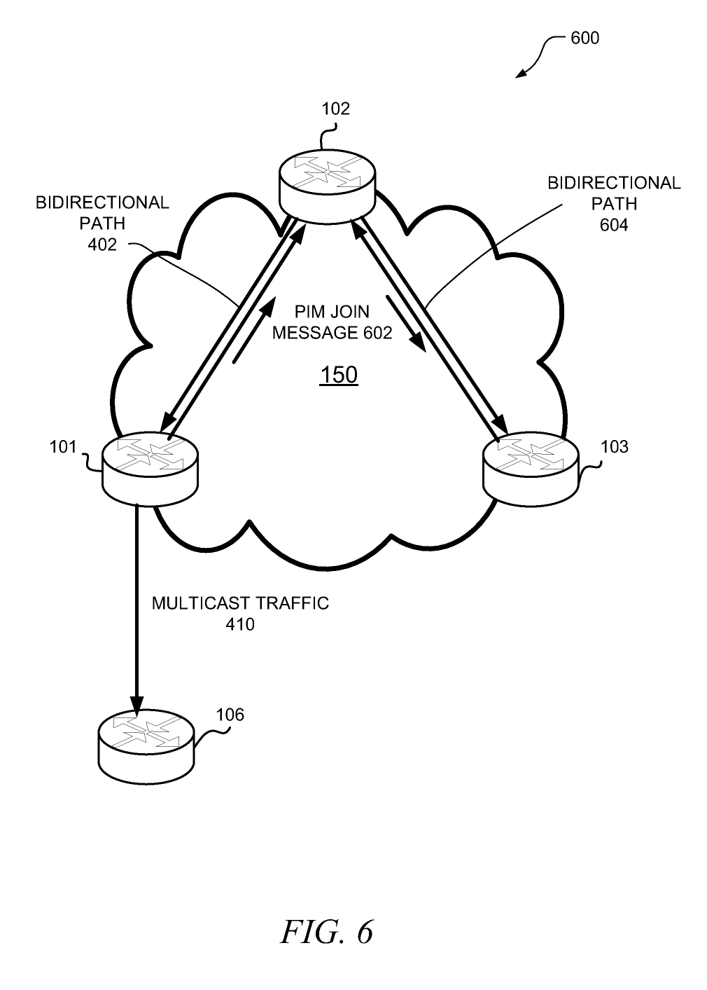

FIG. 6 depicts a diagram illustrating the relaying of an interest for multicast traffic, in accordance with an example embodiment. The computer network 600, as depicted, includes a provider domain 150 that is interconnected by PE routing devices 101-103. Additionally included in the computer network 600 is a CE routing device 106 that is in communication with the provider edge routing device 101. Within the provider domain 150 is a multicast virtual private network.

In this example, a bidirectional path 402 has been created between PE routing devices 101 and 102 such that PE routing device 102 can receive control messages within a customer domain (not shown), such as a PIM join message 602. In the creation of the bidirectional path 402, the PE routing device 101 may transmit a PIM join message 602 to the PE routing device 102. Upon receipt of this PIM join message 602, the PE routing device 102 creates another bidirectional path 604 to another PE routing device 103 in the point-to-multipoint path. Upon the creation of the bidirectional path 604, the PE relays this PIM join message 602 to the PE routing device 103. The PIM join message 602 notifies the PE routing device 103 that there is already bidirectional connectivity between PE routing devices 101 and 102.

As a result, the PE routing device 103 is automatically configured to trigger join suppression where it will not transmit any additional PIM join messages to, for example, PE routing device 102. It should be noted that in the relay, the PE routing device 101 also receives its PIM join message back from the PE routing device 102, but the PE routing device 101 is configured to automatically reject any packets that originated from itself. It should be noted that PE routing device 103 may also create a bidirectional path between itself and PE routing device 102. Here, the PE device 102 may relay control messages transmitted between PE routing devices 101 and 103, and thereby achieving join suppression and prune override.

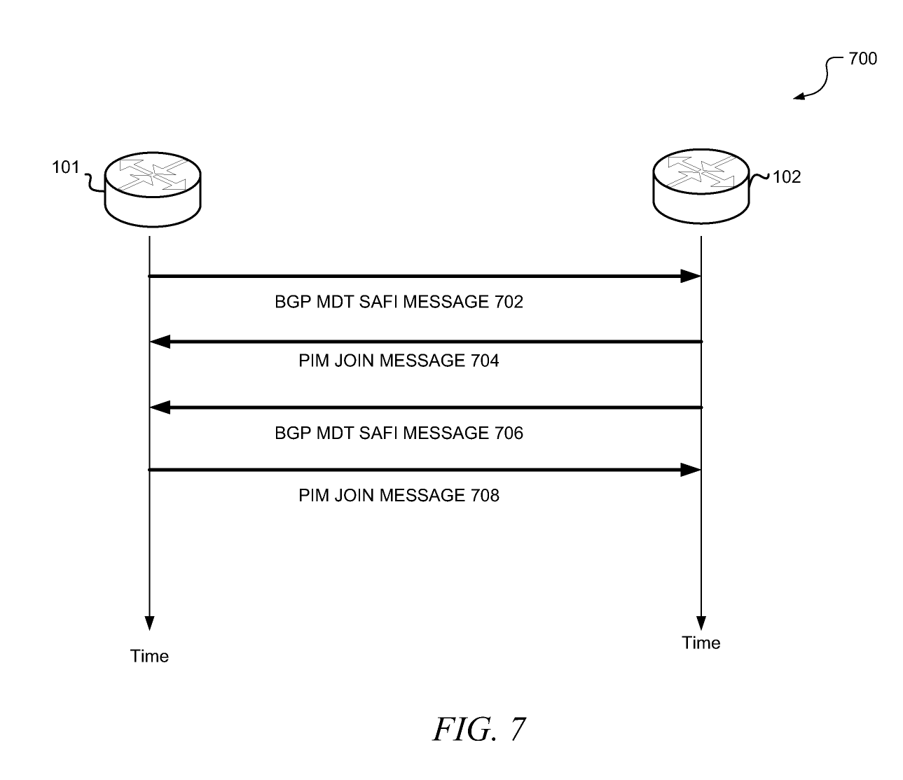

FIG. 7 depicts a timing diagram 700 illustrating the creation of a bidirectional path between two routing devices 101 and 102 based on PIM source specific multicast protocol, according to an example embodiment. The timing diagram 700 illustrates a routing device 101 and an upstream routing device 102. In general, a single bidirectional path can be created based on two unidirectional paths using, for example, PIM source specific multicast protocol, which may be implemented in the provider domain. In PIM source specific multicast protocol, each unidirectional path may be triggered by BGP MDT SAFI or BGP A-D.

As depicted in FIG. 7, the routing device 102 connected to a multicast source and/or a customer multicast rendezvous point is initially known and this routing device 102 initiates a BGP MDT SAFI update. That is, the routing device 102 knows that it is connected to multicast sources and therefore may trigger the BGP MDT SAFI update. Upon receipt of an interest for multicast traffic (e.g., a PIM join message or IGMP report message), the routing device 101 transmits a Multicast Distribution Tree (MDT) subaddress family identifier information (SAFI) message 702 to the upstream routing device 102 by way of border Gateway protocol (BGP). The MDT-SAFI message 702 particularly includes a source PE (a source address) and a default Multicast Distribution Tree (MDT) group (a multicast group address). Since the MDT SAFI message 702 is transmitted by way of BGP in this example, a MDT SAFI message 702 may also be referred to as a BGP MDT SAFI message.

Upon receipt of the BGP MDT SAFI message 702, the upstream routing device 102 creates a unidirectional path to the routing device 101 by connecting the routing device 101 to the bidirectional multicast distribution core tree. To create this unidirectional path, the upstream routing device 102 transmits a PIM join message 704 and another BGP MDT SAFI message 706 to the routing device 101.

Upon receipt of the PIM join message 704 and the BGP MDT SAFI message 706 from the upstream routing device 102, the routing device 101 creates another unidirectional path to the upstream routing device 102 by connecting the upstream routing device 102 to the bidirectional multicast distribution core tree. The routing device 101 may create this unidirectional path by transmitting another PIM join message 708 to the upstream routing device 102.

At this point, a bidirectional path has been created by way of two unidirectional paths. It should be noted that if a route reflector (not shown) is located between routing devices 101 and 102, the route reflector transparently relays the messages 702, 706, and 708 between the routing devices 101 and 102.

In an alternative embodiment, the routing devices 101 and 102 may exchange Auto-Discovery (A-D) routes by way of BGP instead of BGP MDT SAFI messages 702 and 706. It should be noted that when A-D routes are exchanged between routing devices 101 and 102, filtering mechanisms can be used to limit the learning and/or processing of A-D routes by downstream routing device 101 that wants to receive multicast traffic from the upstream routing device 102 advertised in these A-D routes. Such filtering is applied to A-D routes and not to BGP MDT SAFI. This filtering may therefore, for example, make core tunnel building procedure more efficient as only the interested downstream routing device 101 processes such A-D routes.

As discussed above, the bidirectional path is dynamically created as needed and removed when not needed. In PIM source specific multicast protocol, for example, the downstream routing device 101 transmits a PIM prune message (not shown) to the upstream routing device 102 and withdraws BGP (SAFI or A-D) update once, for example, a predefined period of time after withdrawal of interest for multicast traffic by the PE routing device 102 has lapsed. This PIM prune message removes the unidirectional path from upstream routing device 102 to routing device 101. Based on the BGP MDT SAFI (or A-D update), the upstream routing device 102 also transmits a PIM prune message to the downstream routing device 101, at which point removing the unidirectional path from routing device 101 to routing device 102, thereby resulting in the removal of the bidirectional path between routing devices 101 and 102.

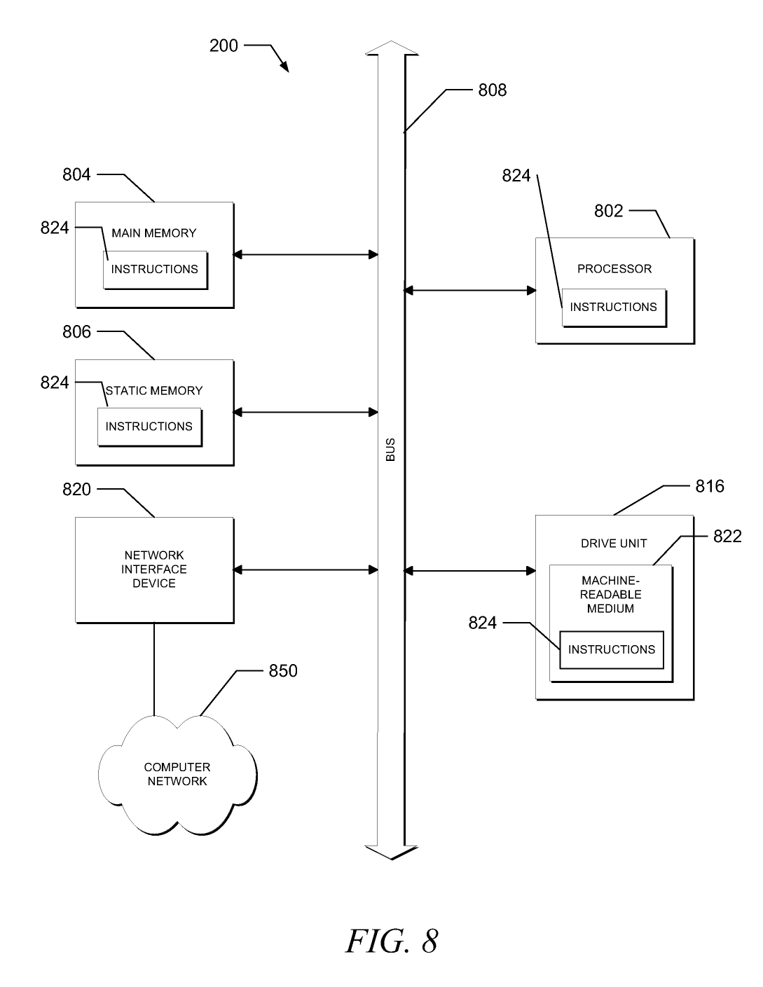

FIG. 8 depicts a block diagram of a machine in the example form of an apparatus 200 within which may be executed a set of instructions for causing the machine to perform any one or more of the methodologies discussed herein. The machine is connected (e.g., networked) to other machines and is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the apparatus 200 includes a processor 802 (e.g., a central processing unit (CPU)), a main memory 804 (e.g., random access memory (a type of volatile memory)), and static memory 806 (e.g., static random access memory (a type of volatile memory)), which communicate with each other via bus 808. The apparatus 200 may also include a disk drive unit 816 and a network interface device 820.

The disk drive unit 816 (a type of non-volatile memory storage) includes a machine-readable medium 822 on which is stored one or more sets of data structures and instructions 824 (e.g., software) embodying or utilized by any one or more of the methodologies or functions described herein. The data structures and instructions 824 may also reside, completely or at least partially, within the main memory 804 and/or within the processor 802 during execution thereof by apparatus 200, with the main memory 804 and processor 802 also constituting machine-readable, tangible media. The data structures and instructions 824 may further be transmitted or received over a computer network 850 via network interface device 820 utilizing any one of a number of well-known transfer protocols.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the apparatus 200) or one or more hardware modules of a computer system (e.g., a processor 802 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor 802 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a processor 802 (e.g., a general-purpose processor) configured using software, the processor 802 may be configured as respective different hardware modules at different times. Software may accordingly configure the processor 802, for example, to constitute a particular hardware module at one instance of time and to constitute a different hardware module at a different instance of time.

Modules can provide information to, and receive information from, other hardware modules. For example, the described hardware modules may be regarded as being communicatively coupled. Where multiples of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 802 or processor-implemented modules. The performance of certain of the operations may be distributed among the one or more processors 802, not only residing within a single machine, but deployed across a number of machines. In some example embodiments, the processor or processors 802 may be located in a single location, while in other embodiments the processors 802 may be distributed across a number of locations.

While the embodiment(s) is (are) described with reference to various implementations and exploitations, it will be understood that these embodiments are illustrative and that the scope of the embodiment(s) is not limited to them. In general, techniques for implementing point-to-multipoint paths in a multicast virtual private network may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

What is claimed is:

1. A method at a first routing device, the method comprising:
receiving an interest for multicast traffic that is transmitted downstream along a point-to-multipoint path in a multicast virtual private network, the interest identifying at least one of a source address or a multicast group address;
identifying a second routing device based on the at least one of the source address or the multicast group address, the second routing device being upstream to the first routing device; and
on condition of receipt of the interest, creating a bidirectional path between the first routing device and the second routing device.

2. The method of claim 1, wherein the creation of the bidirectional path comprises creating a unidirectional path to the second routing device.

3. The method of claim 1, wherein the bidirectional path is created by way of two unidirectional paths based on Protocol Independent Multicast (PIM) source specific multicast protocol.

4. The method of claim 1, wherein the bidirectional path is created by way of two unidirectional paths based on Resource Reservation Protocol-Traffic Engineering (RSVP-TE).

5. The method of claim 1, wherein the bidirectional path is created by way of two unidirectional paths based on multicast label distribution protocol (mLDP).

6. The method of claim 1, further comprising:
identifying a lapse of a period of time after withdrawal by the second routing device of an additional interest for the multicast traffic; and
removing the bidirectional path based on the identification of the lapse of the period.

7. The method of claim 1, wherein the identification of the second routing device comprises conducting a reverse path lookup of an address of the second routing device based on the source address.

8. The method of claim 1, wherein the identification of the second routing device comprises conducting a reverse path lookup of an address of the second routing device based on a rendezvous point associated with the multicast group address.

9. The method of claim 1, wherein the interest for multicast traffic is a Protocol Independent Multicast (PIM) join message.

10. The method of claim 1, wherein the interest for multicast traffic is an Internet Gateway Management Protocol (IGMP) report message.

11. A method at a first routing device, the method comprising:
receiving an interest for multicast traffic from a second routing device that is downstream from the first routing device, the multicast traffic being transmitted downstream along a point-to-multipoint path in a multicast virtual private network;
on condition of receipt of the interest, creating a bidirectional path between the first routing device and a third routing device that is downstream from the first routing device and is in the point-to-multipoint path; and
relaying the interest to the third routing device, the relaying of the interest triggering join suppression at the third routing device.

12. The method of claim 11, wherein the creation of the bidirectional path comprises creating a unidirectional path to the third routing device.

13. The method of claim 11, further comprising:
receiving a Protocol Independent Multicast (PIM) prune message from the second routing device; and
relaying the PIM prune message to the third routing device, the relaying of the interest triggering prune override at the third routing device.

14. The method of claim 11, wherein the point-to-multipoint path is unidirectional.

15. The method of claim 11, wherein the bidirectional path is a single bidirectional path.

16. An apparatus comprising:
a multicast module configured to:
receive an interest for multicast traffic that is transmitted downstream along a point-to-multipoint path in a multicast virtual private network, the interest identifying at least one of a source address or a multicast group address;
identify a routing device based on the at least one of the source address or the multicast group address, the routing device being upstream to the apparatus; and
on condition of receipt of the interest, create a bidirectional path between the apparatus and the routing device.

17. The apparatus of claim 16, wherein the bidirectional path is created by way of two unidirectional paths based on Protocol Independent Multicast (PIM) source specific multicast protocol.

18. An apparatus comprising:
a multicast module configured to:
receive an interest for multicast traffic from a first routing device that is downstream from the apparatus, the multicast traffic being transmitted downstream along a point-to-multipoint path in a multicast virtual private network;
on condition of receipt of the interest, create a bidirectional path between the apparatus and a second routing device that is downstream from the apparatus and is in the point-to-multipoint path; and
relay the interest to the second routing device, the relaying of the interest triggering join suppression at the second routing device.

19. The apparatus of claim 18, wherein the creation of the bidirectional path comprises creating a unidirectional path to the second routing device.

20. The apparatus of claim 18, wherein the bidirectional path is created by way of two unidirectional paths, one unidirectional path of the two unidirectional paths being from the apparatus to the second routing device, another unidirectional path of the two unidirectional paths being from the second routing device to the apparatus.
